(19) United States
(12) Patent Application Publication
(10) Pub. No.: US 2021/0044675 A1
(43) Pub. Date: Feb. 11, 2021

(54) Methods Circuits Devices Systems and Functionally Associated Computer Executable Code for Facilitating Edge Computing on a Mobile Data Communication Network

(71) Applicant: SAGUNA NETWORKS LTD., Yokneam Illit (IL)

(72) Inventors: Daniel Nathan Frydman, Haifa (IL); Lior Fite, Zurit (IL)

(21) Appl. No.: 16/946,687

(22) Filed: Jul. 1, 2020

Related U.S. Application Data
(63) Continuation of application No. 15/331,853, filed on Oct. 22, 2016, now abandoned.
(60) Provisional application No. 62/244,747, filed on Oct. 22, 2015.

(51) Int. Cl. H04L 29/06; H04W 8/00; H04W 36/00; H04L 29/08

(52) U.S. Cl. CPC H04L 67/42; H04W 8/005; H04W 36/0011; H04W 84/042; H04L 67/145; H04L 67/16; H04L 67/289

(57) ABSTRACT

Disclosed are methods, circuits, devices, systems and functionally associated computer executable code to Facilitate Edge Computing on a mobile communication network. According to some embodiments, there may be provided a mobile data communication network comprising two or more Mobile Edge Computing MEC Zones, wherein a first MEC Zone is communicatively coupled to a first set of network access points which are adapted to communicated with User Equipment (UE) and includes at least one Edge Processing Host adapted to run a server-side application accessible to a client application running on an EU communicating with a network access point of the first set of network access points. The network may include an Edge Processing Connectivity Manager (“EPCM”) to provide application session continuity for the client application and the server-side application when the UE switches its network connection from an access point of said first MEC zone to an access point communicatively coupled to an access point coupled to a second MEC zone.

### RELATED APPLICATIONS

The present applications is a continuation of U.S. patent Ser. No. 15/331,853, filed on 22 Oct. 2016, which '853 itself claims priority from U.S. Provisional Patent Application No.: 62/244,747 and filed on Oct. 22, 2015. Both the '853 Pat. App. and the U.S. Provisional Patent Application No.: 62/244,747 is hereby incorporated by reference in its entirety.

### FIELD OF THE INVENTION

The present invention generally relates to the field of wireless communication. More specifically, the present invention relates to methods, circuits, devices, systems and functionally associated computer executable code for facilitating edge computing on mobile data communications network.

### BACKGROUND

Mobile Edge Computing (MEC) is a new concept in Software Defined Networking and Virtualization Technology. MEC is about moving compute and storage to the edge of the mobile network and connecting mobile users using Mobile Breakout to an application residing on the MEC platform optionally running in a VM. When a UE is connected to a local application it still needs to preserve all its capabilities including mobility. When the user is moving in the mobile network it might go out from one MEC zone to a different MEC zone. When moving between MEC zones the IP address of the UE might change on the new MEC server due to NAT issues.

There is need for methods and systems to transparently reconnect the UE to the original application running over the original MEC server from the new MEC server. The reconnection between the UE and the Application session should preformed transparently on all layers (IP, TCP and Applications).

### SUMMARY OF INVENTION

The present invention includes methods, circuits, devices, systems and functionally associated computer executable code for providing edge computing on a mobile data communication network. According to embodiments, there may be provided mobile data communication networks and network architectures including one or more Mobile Edge Computing (“MEC”) zones, wherein each MEC and may be associated with one or more network access points and may include or be otherwise associated with at least one Edge Processing Host (EPH), which EPH's are adapted to run one or more server applications. The present invention may include methods, devices, systems and computer executable code to provide a client application running on a mobile communication device (also referred to as User Equipment (UE)), and communicating with a server-side application (e.g. application engine) running on an EPH within a first MEC zone of the mobile data communication networks, with server-side application session continuity as the mobile communication device moves or otherwise switches from the first MEC zone of the mobile data communication network to a second MEC zone of the mobile data communication network. Application session continuity may be maintained by bridging application session data communications between the second MEC and the first MEC zones, thereby maintaining connectivity or reconnecting the client application running on the UE communicatively coupled to the second MEC zone with the server-side application running on an EPH in the first MEC zone. Application session continuity may also be maintained by transferring server-side application session date, such as session state data, from a first EPH in the first MEC zone to a second EPH in the second MEC zone.

According to some embodiments, each of two or more network access nodes of a mobile data communication network may be located within, or be otherwise associated with, an Mobile Edge Computing (MEC) zone and may be integral or otherwise functionally associated with at least one Edge Processing Host (EPH) which EPH is part of that MEC zone. A mobile data communication network according to embodiments may include multiple MEC zones, each MEC being associated with a separate set of wireless network access points, which wireless access points may be cellular base stations or Wi-Fi hotspots. Each MEC according to embodiments of the present invention may be integral or otherwise functionally associated with a separate set of EPH's, wherein an EPH may be or may include a computational platform including one or more processors, computational memory, and an operating system running a single server at a time, or the computational platform may include an operating system adapted to host multiple virtual servers (e.g. virtual machines) and/or multiple processing containers at the same time. According to yet further embodiments, an EPH may include multiple computational platforms operating in concert (e.g. a grid computer). An EPH, either running a single server (Machine) operating system or running a virtual machine hypervisor (e.g. VMWare) with multiple virtual machines (e.g. virtual servers) instanced/running thereon, may also be referred to as a Mobility Edge Computing Platform (MECP). A server operating system or a virtual machine/server running on an EPH of a specific MEC, according to embodiments, may be referred to as an MEC server.

An EPH according to embodiments may include computational resources such as operating memory, digital processing circuits, and data connectivity circuits for running one or more server-side applications, and may be adapted to allocate at least a portion of its computational resources to application engines or application servers to be accessed through the mobile data communication network. An EPH within a mobile data communication network according to embodiments may have data connectivity to and with other EPH's in the same MEC zone, to and with EPH's in other MEC zones, and with generic network resources across the internet. Client application access to a specific EPH and server-side applications (e.g. application engines) running thereon may be restricted to client applications running on UE's communicatively coupled to an access point associated with the MEC zone of the specific EPH. According to further embodiments, client application access to the specific EPH, and server-side applications running thereon, by a client application running on UE communicatively coupled to an access point associated with an MEC other than the MEC of the specific EPH may be facilitated by an Edge Processing Connectivity Manager (“EPCM”). The EPCM may bridge, or cause another network element to bridge, data communication between the client application running on UE communicatively coupled to an access point associated with an MEC other than the MEC of the specific EPH. The EPCM may redirect or readdress, or cause another network element to redirect or readdress, data communication of the client application and of the specific EPH so as to maintain connectivity despite the two despite them being connected to different MEC zones.

A server-side application or application engine running on an EPH which is functionally associated with a given network access point may be accessible and may provide data services to a corresponding or otherwise associated client application which is running on a mobile communication device communicatively coupled to the mobile data communication network through the given network access point. According to some embodiments of the present invention, the network may include an Edge Processing Connectivity Manager (“EPCM”) adapted to provide session continuity for a client application running on a mobile communication device which is moving or otherwise switching between two network access points, when each network access point is associated with a different MEC and separate EPH's. The EPCM may: (a) (reroute data); and (b) shift the application session data to the MEC zone.

According to some embodiments, the EPMC may be a discrete and/or centralized network resource, network element or set of network elements, such as one or more network appliances connected to the network. According to further embodiments, the EPMC may be decentralized and may be comprised of Mobility Services modules running on portions of each of multiple EPH's which are spread across different MEC zones. For example, at least one Mobility Services module may be located at each MEC zone which participates in a MEC zone group supports server application session continuity, and the Mobility Services modules from each MEC zone of the MEC zone group may communicate with at least one other Mobility Services module located at another MEC zone. According to further embodiments, each Mobility Services module of any MEC zone may communicates with each other Mobility Services module of each other MEC zone within the same MEC zone group. The communication may be in the form of TCP/IP packet transmission to a specific Mobility Services module, a packet unicast to a specific Mobility Services module, and/or a multicast to several or all of the Mobility Services modules of an MEC zone group. Communication between Mobility Services module of different MEC zones may provide for a collaborative computing configuration supporting application session continuity for applications running on UE which is switching between two MEC zones according to embodiments of the present invention.

According to some embodiments, session continuity may be provided and/or maintained for a client application running on an EU which switched its connection to the network between a first access point associated with a first MEC zone and to a second access point associated with a second MEC zone, by reconnecting the client running on the UE to the original application running over the original MEC server of the first MEC zone from the new MEC server of the second MEC zone. The reconnection between the UE and the Application on the MEC server of MEC zone may be performed transparently on all layers (IP, TCP and Applications). As an UE switches its network connection, and server-side application data service requests from client applications running on the UE, to the second MEC zone, a Mobility Services module of the second MEC zone may recognize that server-side application data service requests from the client application running on the newly connected EU are relevant to a server-side application running on an MEC server of a different MEC Zone. The Mobility Services module may transmit a query to one or more Mobility Services modules running in other MEC zones to determine whether and/or which of the MEC servers in the other zones is running the relevant application. Upon receiving an indication and/or a network address of the relevant MEC server, the Mobility Services module in the new MEC zone may forward or otherwise bridge communication from the client application on the UE with the relevant MEC server on in the other MEC zone. Bridging application session packets between the two MEC zones may be performed using Mobility Services modules in both MEC zones as gateways and/or Network Address Translators (NAT) for data packets of the application session. Data communication between the two Mobility Services modules, including signaling packets and payload data such as application session packets, may be communicated using a data tunnel connecting the two modules.

According to further embodiments, application session continuity for a client application running on an UE which is switching from a first MEC zone to a second MEC zone may be maintained by transferring a corresponding server-side application session from a corresponding server-side application running on an MEC server of the first MEC zone to a corresponding server-side application running on an MEC server of the second MEC zone. The corresponding server-side application session may be transferred by copying session state data from the application running on the first zone MEC server and instancing or otherwise creating another session with the copied session state data on an MEC server of the second zone. According to yet further embodiments, a snapshot of the entire first zone server-side application (or container) may be copied and instanced on an MEC server of the second zone. These application session transfers may achieved through a collaborative series of steps performed by Mobility Service modules running on EPH's within the first and second MEC zones.

Embodiments of the present invention, including structure, steps and functions described herein, are applicable to all cellular networks known today or to be device in the future. Embodiments of the present invention, including structure, steps and functions described herein, are applicable to wireless data networks known today or to be device in the future. Embodiments of the present invention, including structure, steps and functions described herein, are applicable to satellite data networks known today or to be device in the future.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A shows a block network diagram of an exemplary mobile data communication network according to embodiments of the present invention including an Edge Processing Host (EPH) connected to each of two Mobile Edge Computing (MEC) zones, wherein each EPH provides application hosting for service-side applications servicing mobile devices (User Equipment) connected to access points of its respective MEC zone, and also to mobile devices connected to access points of other MEC zones when directed by an Edge Processing Connectivity Manager (EPCM);

FIG. 1B shows a network diagram of an exemplary cellular network with two MEC zones, each of which zones includes an EPH (also referred to as Mobile Edge Computing Platform, MEC server, etc.) with one or more MEC server and a Mobility Services module running thereon;

FIG. 2 shows a functional block diagram of at least a portion of an Edge Processing Connectivity Manager (EPCM) according to embodiments of the present invention wherein the EPCM is comprised of Mobility Services modules integral or otherwise functionally associated with one or more access points of an MEC zone, and wherein the EPCM provides application session continuity by bridging application session packets between different MEC zones;

FIGS. 3A to 3D illustrate a sequence of steps for bridging or forwarding application session packets between two separate MEC zones after an UE switches between the two MEC zones according to embodiments of the present invention;

FIG. 4 shows a functional block diagram of at least a portion of an Edge Processing Connectivity Manager (EPCM) according to embodiments of the present invention where the EPCM is comprised of Mobility Services modules integral or otherwise functionally associated with one or more access points of an MEC zone and wherein the EPCM provides application session continuity by copying application session data from an EPH/MEC-Server of one MEC zone to an EPH/MEC-Server of another MEC zone; and

FIG. 5 illustrate the copying of application session data between two MEC zones after an UE switches MEC zones according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE FIGURES

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), any composition and/or architecture of semiconductor based Non-Volatile Memory (NVM), any composition and/or architecture of biologically based Non-Volatile Memory (NVM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other functionally suitable components may be used.

According to embodiments of the present invention, there may be provided a mobile data communication network comprising two or more Mobile Edge Computing (MEC) Zones, wherein a first MEC Zone may be communicatively coupled to a first set of network access points which are adapted to communicated with User Equipment (UE), and the zone may include at least one Edge Processing Host adapted to run a server-side application accessible to a client application running on an EU connecting to the network through a network access point of the first set of network access points. The network may include an Edge Processing Connectivity Manager (“EPCM”) to provide application session continuity for a communication session between the client application of the UE and the server-side application of the first MEC zone when the UE switches its network connection from an access point of said first MEC zone to an access point communicatively coupled to a second MEC zone. The second MEC zone may be communicatively coupled to a second set of network access points which are adapted to communicated with User Equipment (UE), and the second MEC may include at least one Edge Processing Host adapted to run a server-side application accessible to a client application running on an EU communicating with a network access point of the second set of network access points.

According to embodiments, the EPCM may be comprised of Mobility Services modules running within each of said first and second MEC zones, wherein said Mobility Services modules may communicate with one another using cross-zone communication paths, for example through a cross-MEC gateway.

The EPCM may provide application session continuity for the UE client application and the server-side application running on an EPH of said first MEC zone by bridging application session packets between said second MEC zone and said first MEC zone. Bridging application session packets between said second MEC zone and said first MEC zone may include detecting that client application packets of the UE are related to a server-side application session running on a EPH in another MEC zone, polling one or more other MEC zones to determine in which MEC zone the intended application session is running, and establishing network address translation and transport the two MEC zones. The EPCM may be comprised of a Mobility Services module within said first MEC zone in collaborative communication and operating in concert with a Mobility Services module within said second MEC.

The EPCM may provide application session continuity for the UE client application and the server-side application running on an EPH of said first MEC zone by copying application session data from said EPH of said first MEC zone to an EPH of said second MEC zone. Copying application session data from said EPH of said first MEC zone to an EPH of said second MEC zone may include detecting at said second MEC zone that client application packets of the client application on the UE are related to a server-side application session running on a EPH in another MEC zone, polling one or more other MEC zones to determine in which MEC zone the intended application session is running, requesting the application session data from said first MEC zone and instancing on said EPH of said second MEC zone an application session based on the application session data requested from said first MEC zone. The copied application session data may be selected from the group of data consisting of: (a) application session state data, and (b) at least a partial application image snapshot of the server-side application running on said EPH of said first MEC zone. The EPCM may be comprised of a Mobility Services module within said first MEC zone in collaborative communication and operating in concert with a Mobility Services module within said second MEC.

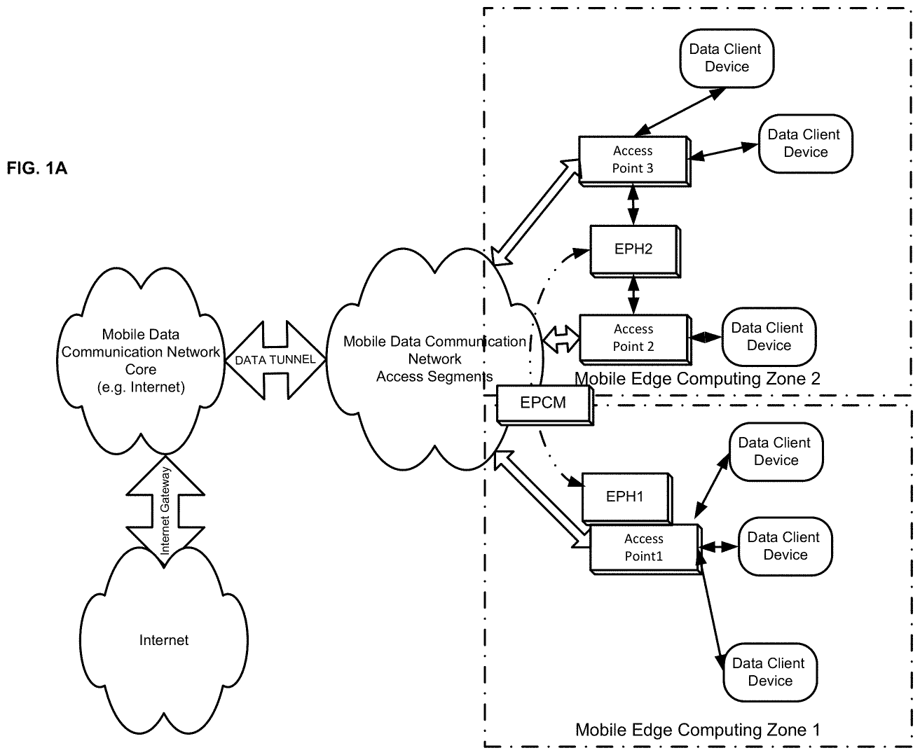

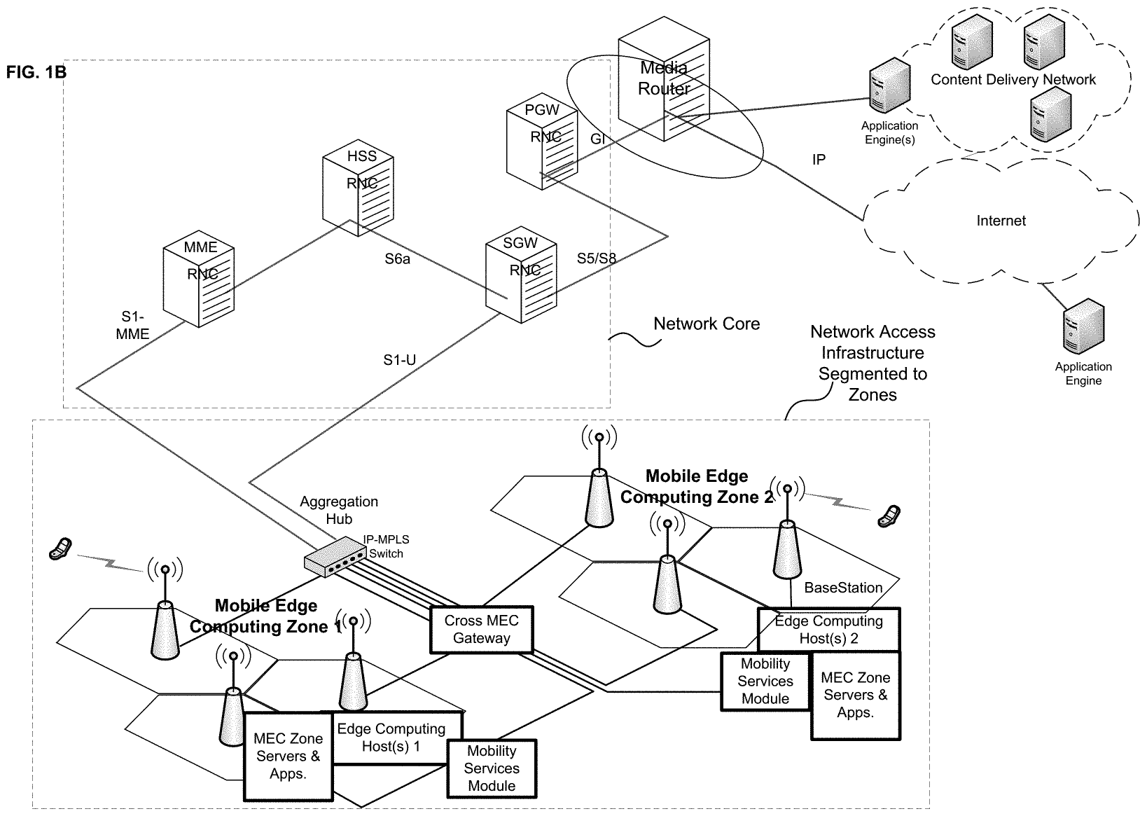

Turning now to FIG. 1A, there is shown a block network diagram of an exemplary mobile data communication network according to embodiments of the present invention including an Edge Processing Host (EPH) in each of two Mobile Edge Computing (MEC) zones, wherein each EPH provides application services to mobile devices (User Equipment) connected to access points of its respective MEC zone and to mobile devices connected to access points of other MEC zones at the direction of an Edge Processing Connectivity Manager (EPCM). The EPCM provides application session continuity for an UE client application and the server-side application running on the EPH of the first MEC zone by bridging application session packets between said second MEC zone and said first MEC zone. Bridging application session packets between said second MEC zone and said first MEC zone include detecting that client application packets of the UE are related to a server-side application session running on a EPH in another MEC zone, polling one or more other MEC zones to determine in which MEC zone the intended application session is running, and establishing network address translation and transport the two MEC zones. The EPCM may be comprised of a Mobility Services module within said first MEC zone in collaborative communication and operating in concert with a Mobility Services module within said second MEC. FIG. 1B shows a network diagram of an exemplary cellular network with MEC zones, each of which MEC zones is associated with several base-stations and includes an EPH (also referred to as Mobile Edge Computing Platform) with one or more MEC servers and a Mobility Services module running thereon. The network of FIG. 1B also shows a cross-MEC zone gateway to facilitate a communication path, for signaling and application session packets, between the first and second MEC zones.

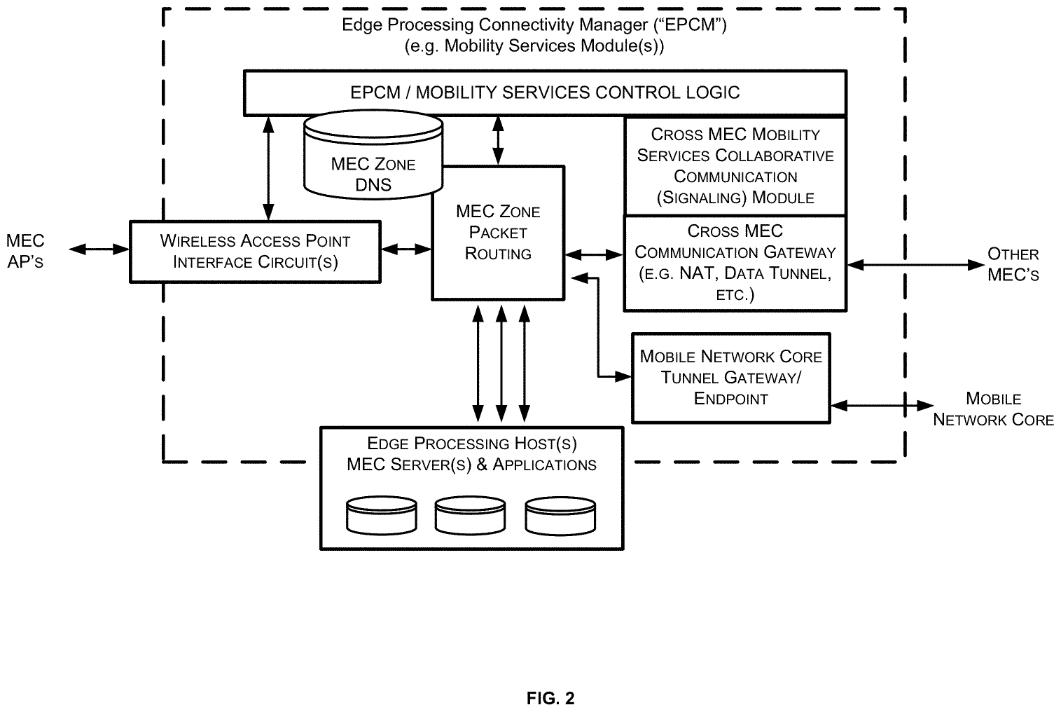

Turning now to FIG. 2 there is shown a functional block diagram of at least a portion of an Edge Processing Connectivity Manager (EPCM) according to embodiments of the present invention, wherein the EPCM is comprised of Mobility Services modules integral or otherwise functionally associated with one or more access points of an MEC zone and wherein the EPCM provides application session continuity by bridging application session packets between MEC zones. The EPCM portion (i.e. Mobility Services module) is associated with a specific MEC zone and has an interface to receive packets from UE connected to associated access points, an MEC zone DNS with routing packet information, an interfaces to the MEC zone's EPH, an interface to the network cored, an interface to a gateway to other MEC zones, a packet routing module, and a controller regulate application session packet routing based on an actual network location of the UE's application session packets—that is, the location of EPH which originated the application session.

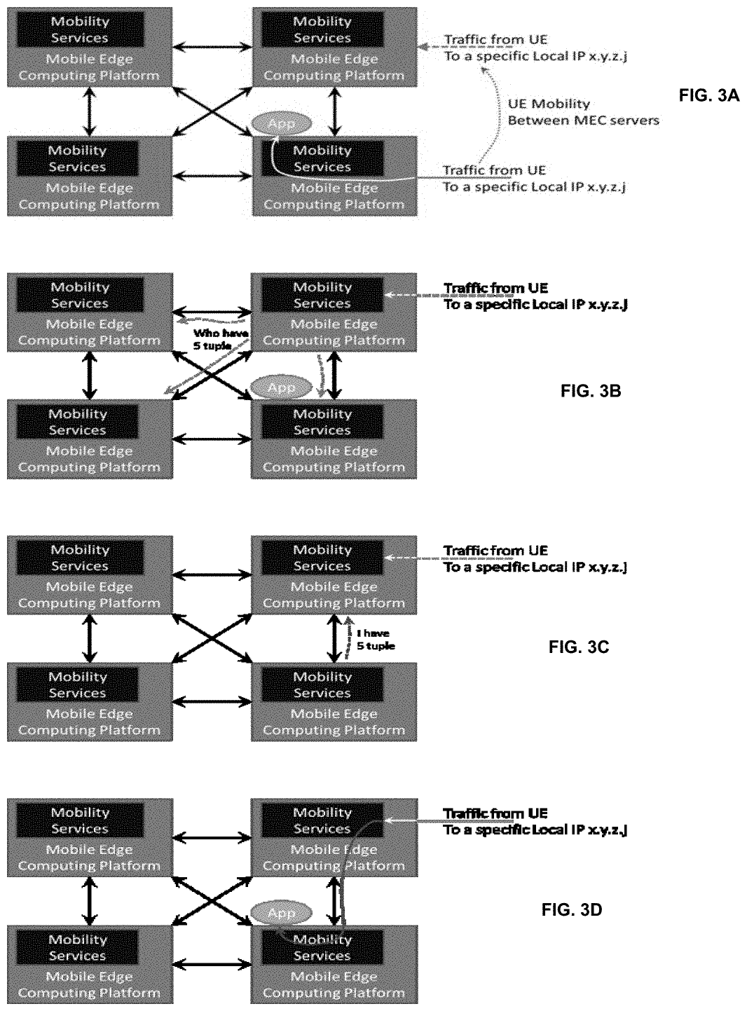

Exemplary operation of the EPCM of FIG. 3 may be described with reference to FIGS. 3A to 3D which illustrate a sequence of steps for bridging application session packets between EPH's of two separate MEC zones after an UE switches between the two MEC zones according to embodiments of the present invention. As seen in FIG. 3A, a User Equipment with a known IP address (IPV4 or IPV6) is connected to a local application. The application may be virtualized on a Virtual Machine, virtualized on a container or running native over the Operating System of an edge server. This server, on an EPH or like, could be any king of server running any king of operating system using any kind of virtualization. Although the model for Mobile Edge Computing (MEC) is used as the example throughout this innovation description, it is also applicable for any NFV/SDN architecture. When the UE is moving in the network it might migrate into a new MEC ZONE which is serviced by a different MEC server. In order for the UE to continue the session with the application, the network should also support the mobility of the application the UE is connected to and the specific session within the application. As seen in FIG. 3A, in order to achieve this, an MEC grid or gateway is required. The MEC grid may connect all MEC server that are part of a MEC Mobility Group—MMG. The MMG is a collection of all MEC zones and respective servers that a UE might migrate to when it is connected to a specific MEC zone, for example, if a UE is connected to MEC-X and under the mobility options the UE can migrate to either MEC-Y, MEC-Z or MEC-J it is said that the MMG of MEC-X includes MEC-Y, MEC-Z and MEC-J and they are the only members in the group. The MMG shall support IP Multicast between group members—it is possible practice to implement this channel over a dedicated IGMP address per MMG.

After the UE migrates into the new MEC system natively it would try to continue the session with the local application it was connected to on the previous MEC server. As Shown in FIG. 3B, this attempt is recognized by at new MEC zone, by the Mobility Services module. Recognition of this may be a result of the specific TCP/UDP ports used by the client application, a specific set of IP Address which is assigned only to MEC applications or by advanced configuration of MEC applications on the MEC servers. Once the MEC server detect traffic which is aimed at a local application from an unknown UE it sends a multicast message to the MMG members including at minimum the 5 tuple of the flow coming from the UE, in case of a tunneling mode (IP over IP, GRE, GTP or any other tunneling mode). The 5 tuple will be composed of the User Plain headers i.e. IP addresses of source and destination, TCP/UDP port of source and destination and protocol type (TCP/UDP).

As seen in FIG. 3C, the MEC zone/server that handled the session related to this 5 Tuple communication will respond to the MEC server that sent the message, with the following information: (a) Application ID—a unique identifier of the application; and (b) Mobility requirements. It is also possible that the MEC server that is holding the Application prior to the mobility event is aware of a possible upcoming mobility evet (information received from the network or any other way) and can send this information either to the MMG or to the target MEC server that is about to receive the UE after a mobility event. For the generality of this invention both options are valid.

The mobility requirements could be for example the following: (1) Mobility not required—this will result in the new MEC server sending a RST to the UE to stop the communication and start a new communication. This is also the default behavior incase no response is received from any of the MMG members; and (2) Connectivity to previous Application—this will result in the traffic from the new MEC server being forwarded over a dedicated tunnel that could be in any format like IP in IP, GRE, SCTP, VLAN, GTP to the previous MEC server. The previous MEC server will then reconnects the communication between the tunneled packets arriving from the UE to the Application As seen in FIG. 3D

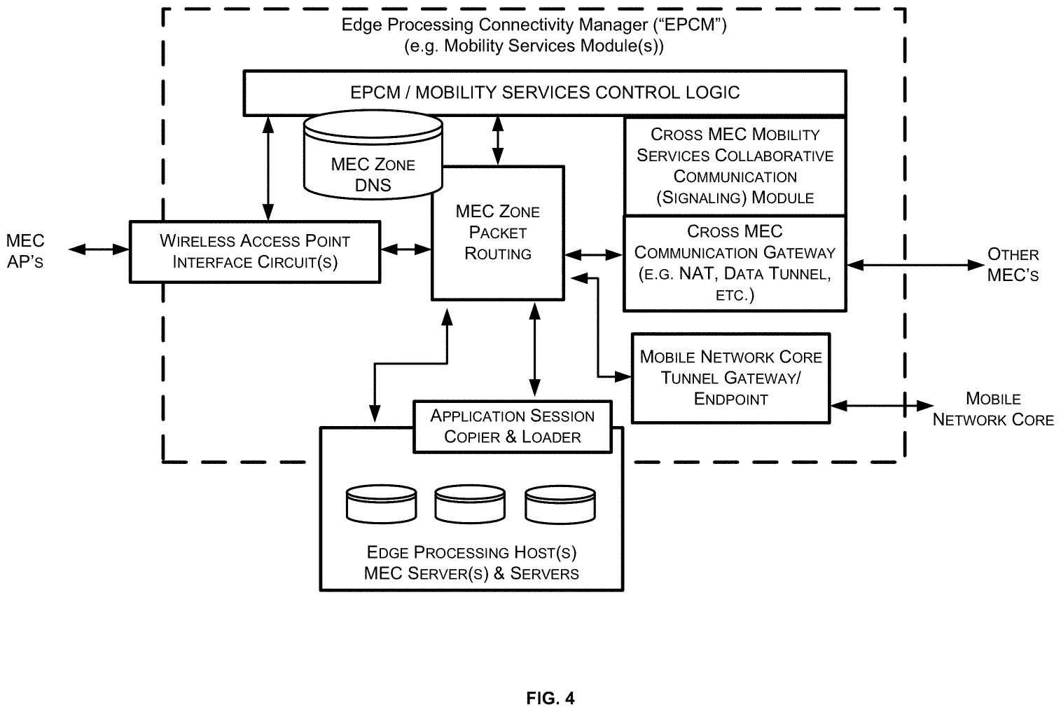

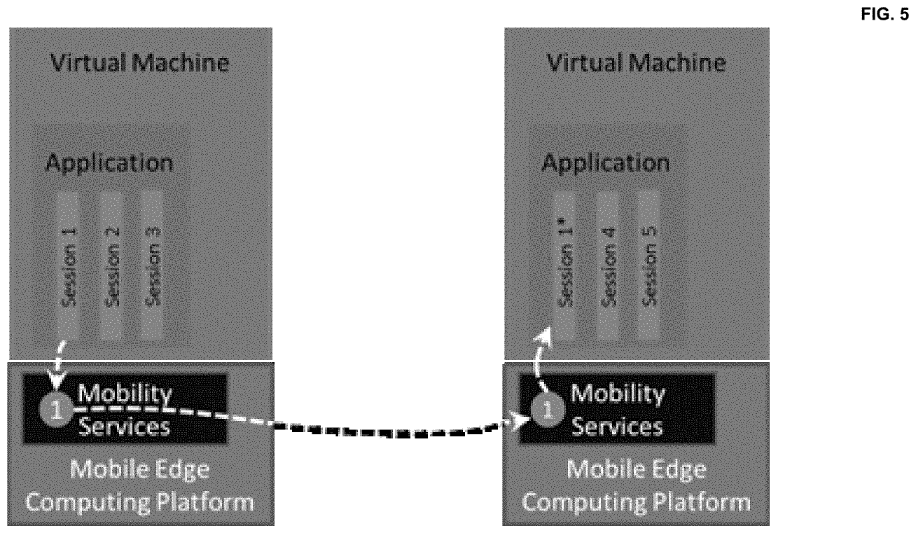

Turning now to FIG. 4, there is shown a functional block diagram of at least a portion of an Edge Processing Connectivity Manager (EPCM) according to embodiments of the present invention, wherein the EPCM is comprised of Mobility Services modules integral or otherwise functionally associated with one or more access points of an MEC zone and wherein the EPCM provides application session continuity by copying application session data from an EPH of one MEC zone to an EPH of another MEC zone. The EPCM of FIG. 4 is similar that the one in FIG. 2 with the addition of session information copying and loading module functionally associated with the EPH to which it is connected. Operation of the EPCM of FIG. 4 can be described with reference to FIG. 5 which illustrate the copying of application session data between two MEC zones after an UE switches MEC zones according to embodiments of the present invention. FIG. 5 illustrates an example where the server-side application is located within a virtual machine of the original MEC zone. The MEC zone server(s) includes a Mobility Service (MS). The MS has an API towards the applications in which the relevant applications are required to save the following: (1) The IP 5 tuple of the session managed; (2) The unique identifier of the Application; (3) The required Mobility Action (as described above); and (4) The application is also allowed to save proprietary information that in case of Application Mobility will allow is to restore the full status of the Application and the specific session or sessions within the application.

When an Application Mobility response is sent, the new MEC server will do the following: (1) If the required application is not running on the new MEC, the MEC server will activate this application; (2) The new MEC server will transfer the proprietary information saved by the application on the Previous MEC server; (3) The new MEC server will alert the running application of the session or sessions regarding the mobility events; (4) The new MEC server will initiate a TCP/UDP connection towards the Application; (5) The new MEC server will proxy the TCP/UDP connection towards the application so the connection towards the UE will not be affected by means of correcting sequence, numbers time-stamps, indexes and etc. Once all is completed the UE is connected to the application running over the new MEC server of the new MEC zone.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Functions, operations, components and/or features described herein with reference to one or more embodiments, may be combined or otherwise utilized with one or more other functions, operations, components and/or features described herein with reference to one or more other embodiments, or vice versa. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A mobile data communication network comprising:
a network core of said mobile data communication network;
at least one mobile data communication network access segments, wherein at least one segment includes two or more Mobile Edge Computing (MEC) Zones, and wherein a first MEC Zone: (a) is communicatively coupled to a first set of network access points which are adapted to communicate with User Equipment (UE); and (b) includes at least one Edge Processing Host adapted to run a server-side application accessible to a client application running on an UE connecting to said network through a network access point of the first set of network access points; and
an Edge Processing Connectivity Manager (“EPCM”) to provide application session continuity for a communication session between the client application of the UE and the server-side application of the first MEC zone when the UE switches its network connection from an access point of said first MEC zone to an access point communicatively coupled to a second MEC zone.

2. The data communication network according to claim 1, wherein said second MEC zone: (a) is communicatively coupled to a second set of network access points which are adapted to communicate with User Equipment (UE); and (b) includes at least one Edge Processing Host adapted to run a server-side application accessible to a client application running on an UE communicating with a network access point of the second set of network access points.

3. The data communication network according to claim 2, wherein said EPCM is comprised of Mobility Services modules running within each of said first and second MEC zones, wherein said Mobility Services modules communicate with one another using cross-zone communication paths.

4. The data communication network according to claim 2, wherein said EPCM provides application session continuity for the UE client application and the server-side application running on an EPH of said first MEC zone by bridging application session packets between said second MEC zone and said first MEC zone.

5. The data communication network according to claim 4, wherein bridging application session packets between said second MEC zone and said first MEC zone includes detecting that client application packets of the UE are related to a server-side application session running on a EPH in another MEC zone, polling one or more other MEC zones to determine in which MEC zone the intended application session is running, and establishing network address translation and transport between the two MEC zones.

6. The data communication network according to claim 4, wherein said EPCM is comprised of a Mobility Services module within said first MEC zone in collaborative communication and operating in concert with a Mobility Services module within said second MEC.

7. The data communication network according to claim 2, wherein said EPCM provides application session continuity for the UE client application and the server-side application running on an EPH of said first MEC zone by copying application session data from said EPH of said first MEC zone to an EPH of said second MEC zone.

8. The data communication network according to claim 7, wherein copying application session data from said EPH of said first MEC zone to an EPH of said second MEC zone includes detecting at said second MEC zone that client application packets of the client application on the UE are related to a server-side application session running on a EPH in another MEC zone, polling one or more other MEC zones to determine in which MEC zone the intended application session is running, requesting the application session data from said first MEC zone and instancing on said EPH of said second MEC zone an application session based on the application session data requested from said first MEC zone.

9. The data communication network according to claim 7, wherein the copied application session data is selected from the group of data consisting of: (a) application session state data, and (b) at least a partial application image snapshot of the server-side application running on said EPH of said first MEC zone.

10. The data communication network according to claim 7, wherein said EPCM is comprised of a Mobility Services module within said first MEC zone in collaborative communication and operating in concert with a Mobility Services module within said second MEC.

11. A method of operating a mobile data communication network comprising:
receiving at each of two or more Mobile Edge Computing (MEC) Zones of the network, located within a data communication network access segments, data packets generated by User Equipment (UE) communicatively coupled to access points of each of the respective MEC Zones;
at a first MEC zone, directing received data packets from a client applications running on a UE communicatively coupled an access point of the first MEC zone towards an Edge Processing Host (EPH) located within first MCE and adapted to run a server-side application corresponding to the client application running on the UE; and
upon the UE switching its network connection from an access point of the first MEC zone to an access point of the second MEC zone, providing application session continuity for a communication session between the client application on the UE and the server-side application in the first MEC zone.

12. The method according to claim 11, wherein providing application session continuity for the UE client application and the server-side application running on an EPH of the first MEC zone includes bridging application session packets between said second MEC zone and said first MEC zone.

13. The method according to claim 12, wherein bridging application session packets between the second MEC zone and the first MEC zone includes detecting that client application packets of the UE are related to a server-side application session running on a EPH in another MEC zone, polling one or more other MEC zones to determine in which MEC zone the intended application session is running, and establishing network address translation and transport between the two MEC zones.

14. The method according to claim 11, wherein providing application session continuity for the UE client application and the server-side application running on an EPH of said first MEC zone includes copying application session data from said EPH of said first MEC zone to an EPH of said second MEC zone.

15. The method according to claim 14, wherein copying application session data from the EPH of said first MEC zone to an EPH of the second MEC zone includes detecting at said second MEC zone that client application packets of the client application on the UE are related to a server-side application session running on a EPH in another MEC zone, polling one or more other MEC zones to determine in which MEC zone the intended application session is running, requesting the application session data from the first MEC zone and instancing on the EPH of said second MEC zone an application session based on the application session data requested from said first MEC zone.

16. The method according to claim 15, wherein the copied application session data is selected from the group of data consisting of: (a) application session state data, and (b) at least a partial application image snapshot of the server-side application running on said EPH of said first MEC zone.
